(19) United States
(12) Patent Application Publication
(10) Pub. No.: US 2016/0039372 A1
(43) Pub. Date: Feb. 11, 2016

(54) ACTUATOR RETAINER

(71) Applicant: AIR INTERNATIONAL (US) INC., Auburn Hills, MI (US)

(72) Inventor: Calogero Alu, Shelby Township, MI (US)

(21) Appl. No.: 14/816,105

(22) Filed: Aug. 3, 2015

Related U.S. Application Data
(60) Provisional application No. 62/033,390, filed on Aug. 5, 2014.

(51) Int. Cl. B60R 16/08; F16K 27/02

(52) U.S. Cl. CPC B60R 16/08; F16K 27/02

(57) ABSTRACT

An actuator retainer according to the present disclosure includes a platform with a first latch projecting upward, a second latch spaced from the first latch and a locating projection projecting upward from the platform.

This application claims priority to U.S. Provisional Patent Application No. 62/033,390 filed Aug. 5, 2014.

### BACKGROUND

Modern vehicles include heating, ventilation, and air conditioning (HVAC) systems for improving passenger comfort.

In general, vehicle air conditioning systems include an evaporator heat exchanger in communication with a compressor and a condenser. A compressor receives heated refrigerant from the evaporator and compresses it into a high pressure gas for communication to the condenser. The condenser then cools the gaseous refrigerant into a cool liquid refrigerant for communication back to the evaporator. A blower forces air across the evaporator, providing cooled air into the engine compartment.

A vehicle heating system includes a heater core that receives hot engine coolant from the engine. A blower forces air across the heater core, providing heated air to the passenger compartment.

Advancements in the field of vehicle HVAC system design and manufacturing are desirable.

### SUMMARY

An actuator retainer according to the present disclosure includes a platform with a first latch projecting upward, a second latch spaced from the first latch and a locating projection projecting upward from the platform.

In a further embodiment of any of the forgoing embodiments, the first latch and the second latch are configured to engage upper platforms in an actuator to retain the actuator against the platform in a vertical direction.

In a further embodiment of any of the forgoing embodiments, the first latch and the second latch limit movement of the actuator in a first direction along the platform and a second direction along the platform.

In a further embodiment of any of the forgoing embodiments, the first latch and the second latch limit movement of the actuator in a second direction along the platform, the second direction opposite the first direction.

A further embodiment of any of the foregoing embodiments includes a second projection projecting upward from the platform and configured to limit movement of the actuator in the direction along the platform.

In a further embodiment of any of the forgoing embodiments, the second projection is opposite the actuator from the locating projection.

In a further embodiment of any of the forgoing embodiments, the second projection is opposite the actuator from the locating projection.

In a further embodiment of any of the forgoing embodiments, the locating projection is configured to be received in an opening in an actuator and to prevent the actuator from moving in a direction along the platform.

In a further embodiment of any of the forgoing embodiments, the second latch is opposite the first latch.

A heat exchange system according to an example of the present disclosure includes a door for controlling fluid flow, an actuator for controlling the door, and a retainer for securing the actuator. The retainer includes a platform, a first latch projecting upward from the platform, and a second latch projecting upward from the platform. The second latch is spaced from the first latch and a locating projection projecting upward from the platform.

In a further embodiment of any of the foregoing embodiments the actuator includes an opening configured to receive the locating projection.

In a further embodiment of any of the forgoing embodiments, the actuator is secured to the retainer free of fasteners.

In a further embodiment of any of the forgoing embodiments, the actuator includes a first platform configured to be engaged by the first latch and a second platform configured to be engaged by the second latch.

In a further embodiment of any of the forgoing embodiments, the first latch and the second latch limit movement of the actuator in a first direction along the platform.

In a further embodiment of any of the forgoing embodiments, the first latch and the second latch limit movement of the actuator in a second direction along the platform. The first direction is opposite the second direction.

A further embodiment of any of the foregoing embodiments includes a second projection extending from the platform. The locating projection is disposed at a first side of the actuator and the second projection is disposed at a second side of the actuator opposite the first side.

In a further embodiment of any of the forgoing embodiments, the platform includes a planar upper surface configured to abut a lower surface of the actuator.

In a further embodiment of any of the forgoing embodiments, the first latch is opposite the actuator from the second latch.

In a further embodiment of any of the forgoing embodiments, the retainer is mounted to an HVAC module.

### BRIEF DESCRIPTION OF THE DRAWINGS

The drawings can be briefly described as follows:

FIG. 1 schematically illustrates a vehicle HVAC system.

FIG. 2 is a perspective view of a housing for an actuator.

FIG. 3 is a perspective view of an actuator retainer.

FIG. 4 is a top view of the actuator retainer of FIG. 3.

FIG. 5 is a perspective view of the actuator retainer mounted to the HVAC system.

FIG. 6 is a top-perspective view of the actuator retainer of FIG. 3.

FIG. 7 is a top view of a second example actuator.

### DETAILED DESCRIPTION

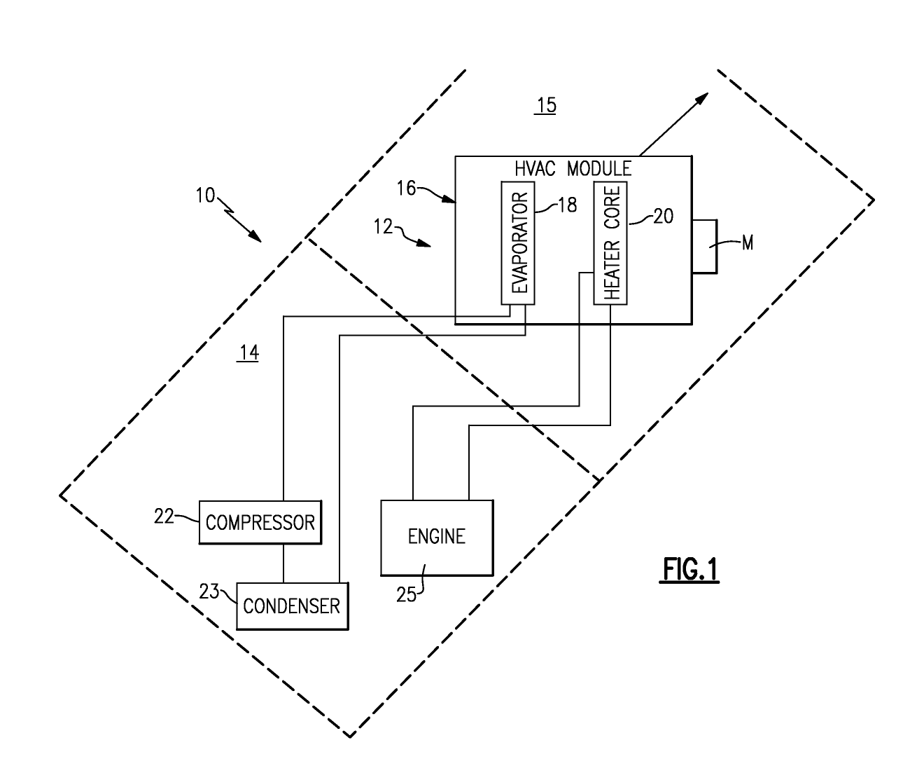

FIG. 1 illustrates schematically a vehicle 10 having an HVAC system 12 located in a passenger cabin area 15 for communicating heated or cooled air to the cabin area 15. For example, the HVAC system 12 may be mounted in the instrument panel or dashboard of vehicle 10, remotely in the rear of a vehicle 10 such as a van or truck, or even in the center console. The example HVAC module 16 of the HVAC system 12 includes an evaporator core 18 for the air conditioning system and a heater core 20 for the heating system.

The evaporator core 18 communicates heated refrigerant gas to the compressor 22, which compresses the refrigerant into a high pressure gas to be communicated to the condenser 23. The condenser 23 condenses the refrigerant into a cooled liquid refrigerant for communication back to the evaporator 18.

The heater core 20 is in communication with the engine 25 for communicating heated liquid to the heater core 20 and cool liquid back to the engine 25. The compressor 22, condenser 23, and engine 25 are located in the engine bay area 14.

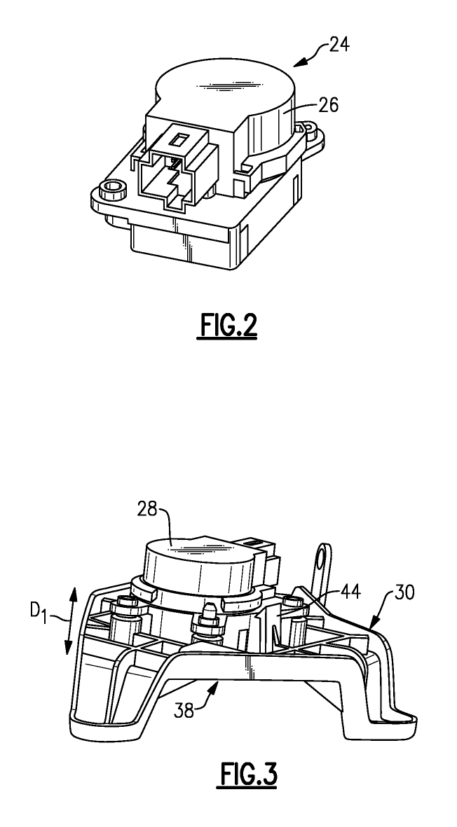

The HVAC system 12 may include one or more actuator assemblies M for opening and closing doors (i.e., valves) that are internal to the module 16 to control airflow, such as the flow of fluid across evaporator 18 and/or heater core 20 and/or flow to specific areas of the vehicle cabin area 15. An example of such an actuator assembly 24 is illustrated in FIG. 2. The example actuator assembly 24 includes a housing 26, having one or more parts, supporting an actuator 28 (FIG. 3). One of ordinary skill in the art having the benefit of this disclosure would realize that other actuator assembly applications may be used.

FIG. 3 illustrates an example actuator retainer 30 according to this disclosure. It should be understood that the actuator retainer 30 may be formed integrally, as one plastic piece. The actuator retainer 30 need not be plastic, however.

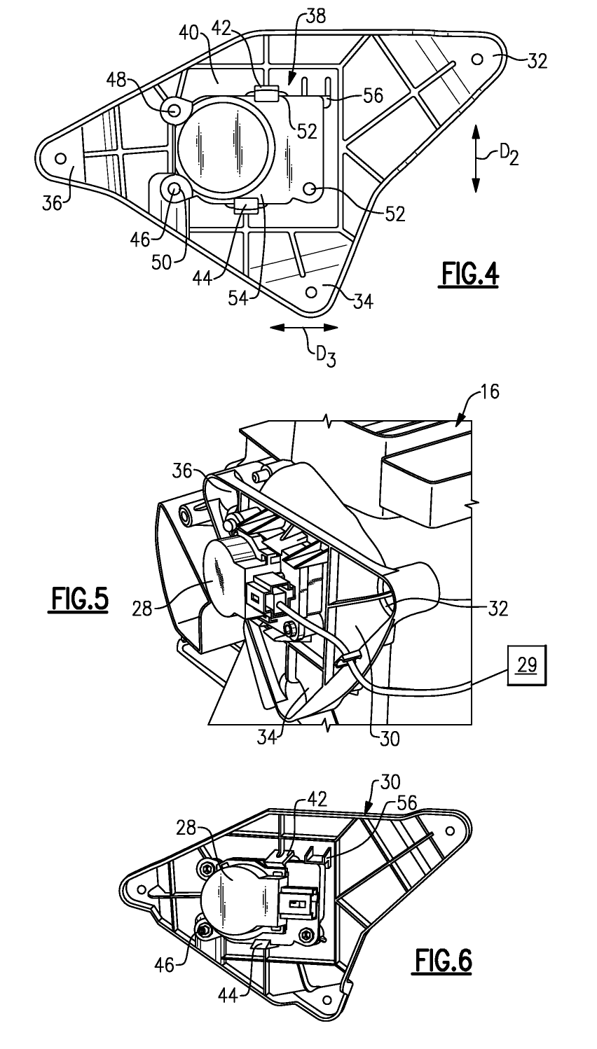

The actuator retainer 30 includes, in this example, three mounting flanges 32, 34, 36 (FIGS. 4, 5, and 6) for mounting the retainer 30 to the HVAC module 16, for example. Alternatively, the retainer 30 may be integrally formed with the HVAC module 16. The example actuator drives doors 29 internal to the HVAC module 16, shown schematically. The doors 29, for example, may control temperature (hot and cold air), modes (defrost, vent, floor), dual zone (driver and passenger), or tri-zone (driver, passenger, rear) options or fresh air intake of the HVAC system 12.

The retainer 30 includes an actuator retention platform 38 between the mounting flanges 32, 34, 36. In this example, the retention platform 38 is elevated, in the direction D₁, relative to the mounting flanges 32, 34, 36. In the example, when the retainer 30 is mounted, the direction D1 is substantially horizontal. Further, the retention platform 38 includes an upper surface 40, which is relatively planar, and is configured to directly contact a lowermost surface of the actuator 28. In this example, a pair of latches 42, 44 extend upward from the upper surface 40. A locating projection 46 may also extend upward from the upper surface 40. In one example, when the retainer 30 is mounted, the platform 38 extends along a vertically oriented plane (see FIG. 5). Thus, features denoted herein as extending “upward” from the platform 38 will extend horizontally when mounted. Of course, other mounting orientations are contemplated.

In this example, the actuator 28 has three mounting openings 48, 50, 52. As illustrated in FIG. 4, the actuator 28 is mounted relative to the retainer 30 such that the locating projection 46 is received in the mounting opening 50. Only one locating projection 46 is used to properly position the actuator 28 relative to the retainer 30. Although the locating projection 46 is received in the opening 50 in this example, the locating projection 46 could be received in one of the other openings 48 or 52. The locating projection 46 prevents unwanted movement of the actuator 28 in the directions D₂ and D₃, for example. Alternatively, the actuator 28 may not include any openings for receiving projections.

The latches 42, 44 engage respective platforms 52, 54 formed in the upper surface of the actuator 28 to retain the actuator 28 against the retainer 30 in the direction D₁. The latches 42, 44 also limit movement of the actuator 28 in the directions D₂. In this example, movement of the actuator 28 relative to the retainer 30 in the directions D₂ is further restricted by another projection 56, which projects upwardly from the upper surface 40 and is arranged generally on an opposite side of the actuator 28 as the projection 46. The projection 56 is not required in all examples. Alternatively, more than one additional projection 56 may be used.

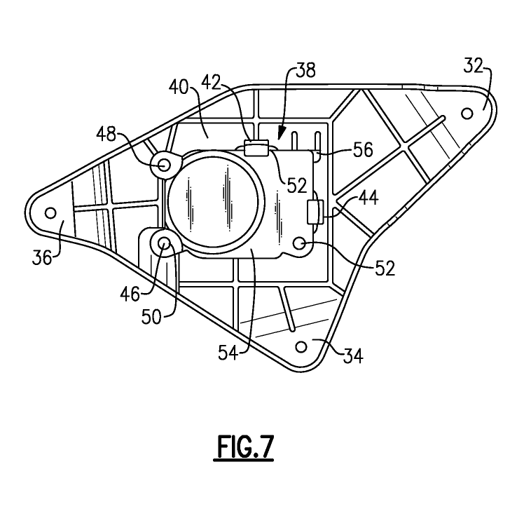

The latches 42, 44 in the example are located opposite the actuator 28 from one another, but other orientations are contemplated. For example, as shown in FIG. 7, the latch 44 may be oriented 90 degrees from the latch 42. Moreover, one of ordinary skill in the art having the benefit of this disclosure would recognize that more or fewer than two latches may be used.

This disclosure provides an effective actuator retainer that does not require fasteners between the actuator 28 and the retainer 30. The snap fitting created by the latches 42, 44 does not require any fasteners for actuator retention. Since no fasteners are required, assembly time is reduced.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. An actuator retainer, comprising:
a platform;
a first latch projecting upward from the platform;
a second latch projecting upward from the platform, the second latch spaced from the first latch; and
a locating projection projecting upward from the platform.

2. The actuator retainer as recited in claim 1, wherein the first latch and the second latch are configured to engage upper platforms in an actuator to retain the actuator against the platform in a vertical direction.

3. The actuator retainer as recited in claim 2, wherein the first latch and the second latch limit movement of the actuator in a first direction along the platform.

4. The actuator retainer as recited in claim 3, wherein the first latch and the second latch limit movement of the actuator in a second direction along the platform, the second direction opposite the first direction.

5. The actuator retainer as recited in claim 3, comprising a second projection projecting upward from the platform and configured to limit movement of the actuator in the direction along the platform.

6. The actuator retainer as recited in claim 5, wherein the second projection is opposite the actuator from the locating projection.

7. The actuator retainer as recited in claim 1, wherein the locating projection is configured to be received in an opening in an actuator and to prevent the actuator from moving in a direction along the platform.

8. The actuator retainer as recited in claim 1, wherein the second latch is opposite the first latch.

9. A heat exchange system comprising:
at least one door for controlling fluid flow;
an actuator for controlling the at least one door;
a retainer for securing the actuator, the retainer comprising
a platform;
a first latch projecting upward from the platform;
a second latch projecting upward from the platform, the second latch spaced from the first latch; and
a locating projection projecting upward from the platform.

10. The heat exchange system as recited in claim 9, wherein the actuator includes an opening configured to receive the locating projection.

11. The heat exchange system as recited in claim 9, wherein the actuator is secured to the retainer free of fasteners.

12. The heat exchange system as recited in claim 9, wherein the actuator includes
a first platform configured to be engaged by the first latch; and
a second platform configured to be engaged by the second latch.

13. The heat exchange system as recited in claim 12, wherein the first latch and the second latch limit movement of the actuator in a first direction along the platform.

14. The heat exchange system as recited in claim 13, wherein the first latch and the second latch limit movement of the actuator in a second direction along the platform, the first direction opposite the second direction.

15. The heat exchange system as recited in claim 9, comprising a second projection extending from the platform, wherein the locating projection is disposed at a first side of the actuator, and the second projection is disposed at a second side of the actuator opposite the first side.

16. The heat exchange system as recited in claim 9, wherein the platform includes a planar upper surface configured to abut a lower surface of the actuator.

17. The heat exchange system as recited in claim 9, wherein the first latch is opposite the actuator from the second latch.

18. The heat exchange system as recited in claim 9, comprising an HVAC module, wherein the retainer is mounted to an HVAC module.

19. The heat exchange system as recited in claim 9, comprising an HVAC module, wherein the retainer is integral with an HVAC module.
